(19) United States
(12) Patent Application Publication
(10) Pub. No.: US 2024/0020425 A1
(43) Pub. Date: Jan. 18, 2024

(54) SECURE TIME SOURCE FOR TRUSTED EXECUTION ENVIRONMENTS

(71) Applicant: NEC Laboratories Europe GmbH, Heidelberg (DE)

(72) Inventors: Samira Briongos, Heidelberg (DE); Claudio Soriente, Heidelberg (DE); Felix Klaedtke, Heidelberg (DE); Ghassan Karame, Bochum (DE)

(21) Appl. No.: 17/879,805

(22) Filed: Aug. 3, 2022

Related U.S. Application Data
(60) Provisional application No. 63/347,033, filed on May 31, 2022.

(51) Int. Cl. G06F 21/72; G06F 21/53; G06F 21/74

(52) U.S. Cl. CPC G06F 21/725; G06F 2221/033; G06F 21/74; G06F 21/53

(57) ABSTRACT

A method provides trusted timing services to an enclave of a computer having memory and a trusted hardware timer. The computer executes a privileged management program and an untrusted operating system. The privileged management program has access to the memory and the trusted hardware timer, has higher privileges than the untrusted operating system, and exposes a system call to the enclave for requesting the trusted timing services. The method includes: receiving, by the privileged management program, a request for timing services from the enclave, via the system call; reserving, by the privileged management program, a memory region of the memory for tracking time; and writing, by the privileged management program, at least one value of the trusted hardware timer into the memory region.

### CROSS-REFERENCE TO RELATED APPLICATIONS

Priority is claimed to U.S. Provisional Patent Application No. 63/347,033, filed on May 31, 2022, the entire disclosure of which is hereby incorporated by reference herein.

### FIELD

The present invention relates to a method, system and computer-readable medium for providing a secure time source for trusted execution environments.

### BACKGROUND

Trusted execution environments (TEEs)—such as INTEL software guard extensions (SGX) or ARM TrustZone—provide hardware supported shielded environments for applications executing inside them, which ensures isolation from the rest of the software stack and even prevents privileged software from directly manipulating the trusted application runtime state. TEEs also benefit from some services usually supported by an untrusted OS—such as sealing (encrypted and authenticated storage) or access to a coarse-grained clock service.

When using TEEs, only certain privileged and trusted code has access to hardware resources. Therefore, in order to prevent code running inside TEEs from hijacking hardware resources, the code runs in user privilege mode and does not have direct access to such resources. This approach is also helpful to maximize compatibility with existing operating systems (OSs). As a result, TEEs need to either request temporary and exclusive access to a peripheral device or invoke an untrusted party via an outside call (ocall—i.e., an outside call to a predefined function).

In the first scenario—common in ARM or RISC-V based architectures, TEEs request access to the secure-monitor. In the latter case—e.g. the SGX scenario—the untrusted party take cares of performing the task. In both cases, the OS usually acts as an intermediary because the OS is typically the party in charge of managing the hardware resources or handling inter-process communication. Because the OS is not part of group of trusted systems that can provide a secure environment for the execution of operations, e.g., is not part of the trusted computing base (TCB)—and therefore is not trusted by a TEE—a compromised OS can intentionally mount delay attacks by generating some interruptions that alter the regular execution flow of the code inside a TEE, or by not delivering the messages exchanged between the trusted party and the TEEs in a timely and reliable way. The messages exchanged among processes can be sent encrypted to ensure confidentiality and integrity of the exchanged data. However, encryption does not protect against such delaying attacks.

Many information technology (IT) applications—e.g., in areas like internet-of-things (IoT), banking, or connected vehicles—rely on the existence of accurate timing information and would suffer from such attacks. Furthermore, the inventors have recognized that accurate and reliable measurements of elapsed time are essential to ensure safe operation of the hardware or the network system (e.g., when measuring round trip times of packages), to evaluate the performance of critical operations, and even to detect malware or microarchitecture attacks as they cause timing anomalies on the execution of some functions.

While TEEs provide confidentiality and integrity guarantees for applications, the inventors have identified that current TEEs do not offer access to a trusted source of time, which is particularly important for TEE applications to be able to self-monitor their performance and security.

Because TEEs do not have access to a trusted (and fine-grained) source of time, currently the TEEs need to rely on an external party to get such information. Such an external party could be the untrusted OS (as aforementioned) or a remote party, either of which making the timer vulnerable to attacks and manipulations or increasing latency in an unpredictable way. Alternatively, the TEE enclave might try to build its own fine-grained timer by using a counting thread. The inventors have determined that this approach is not reliable for accurate timing measurements as an untrusted OS might interrupt or de-schedule such thread. Further, solutions based on timing threads are not scalable as they consume one virtual core per application implementing such timer.

### SUMMARY

An aspect of the present disclosure provides a method enabling trusted timing services to an enclave of a computer having memory and a trusted hardware timer. The computer executes a privileged management program and an untrusted operating system. The privileged management program has access to the memory and the trusted hardware timer, has higher privileges than the untrusted operating system, and exposes a system call to the enclave for requesting the trusted timing services. The method includes: receiving, by the privileged management program, a request for timing services from the enclave, via the system call; reserving, by the privileged management program, a memory region of the memory for tracking time; and writing, by the privileged management program, at least one value of the trusted hardware timer into the memory region.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates an embodiment of a system model;

FIG. 2 illustrates an exemplary set of memory fields for tracking reliable time measurements; and

FIG. 3 illustrates an embodiment of a procedure to measure time;

FIG. 4 further illustrates the embodiment of the procedure to measure time; and

FIG. 5 further illustrates the embodiment of the procedure to measure time.

### DETAILED DESCRIPTION

One or more aspects of the present disclosure provide a trusted and secure source of time measurement for TEE applications (even in the presence interruptions), which may avoid potential disruptions to—and increases the security of—the functioning of the TEE (e.g., protecting against an OS that delays the passage of messages between the TEE and a trusted party, or against an OS that provides interruptions to the execution of functions in the TEE).

Compared to previous approaches in the art, embodiments of the present disclosure preserve computing resources, are scalable, and do not require the consumption of a virtual core to utilize a trusted time source. Embodiments according the present disclosure advantageously also do not require any modifications to the OS and can be integrated with existing TEE instantiations. Embodiments of the present disclosure provide technological improvements to the functioning of a computer. For example, embodiments can improve the security of TEEs (including the securing of applications running at least partially in the TEEs) and improve processing time, as compared to prior approaches in the art with TEEs that do not have the secured time measurement mechanism offered by the present disclosure. Embodiments of the present disclosure also improve the function of IoT systems by ensuring access to a trusted and reliable timing resource, which if fine grained, allows for distribution of the timing across multiple components, reducing latency and increasing security.

An aspect of the present disclosure provides a mechanism to reliably devise a secure source of time for TEE applications. A mechanism provided according to an aspect of the present disclosure securely measures elapsed time between two events executed within the TEE (also known as enclave in some contexts), both measuring the time when the enclave was executing and the actual real elapsed time. For example, whenever the enclave is involved in a context switch (e.g., because of the OS scheduler, an interrupt, or a syscall), the mechanism is triggered updates the timing information for the enclave. The timing information may include the elapsed time and/or interrupt counter.

Aspects of the present disclosure enable enclaves to measure elapsed time reliably by directly exposing, to the enclaves, certain interfaces to a privileged and trusted system management program (referred to herein as a privileged management program for short and a primary example of which is system firmware) in the form of system calls (syscalls), where the direct exposure means that the shielded environment allows for communication with a program that would not otherwise interact with the enclave. The enclaves can thereby directly communicate with the system's trusted program, avoiding the interference of the OS.

According to an aspect of the present disclosure, the privileged and trusted system program (e.g., system firmware) introduces a protected memory region for each of the enclaves on the machine, where timing information and interruptions that alter the regular execution flow of the enclave are stored. The privileged and trusted system program (e.g., system firmware) has direct and privileged (e.g., sole write access) to protected memory, which is used for the protected memory region.

According to a preferred implementation of the present disclosure: (1) trusted firmware and trusted hardware are provided, (2) the firmware has direct access to a hardware clock/timer and protected memory, (3) the firmware runs in a privileged mode (e.g., most privileged mode) of the machine, and (4) the firmware exposes one or more direct system calls to the enclaves for requesting timing data.

According to an aspect of the present disclosure, the firmware reserves different private memory regions—one for each enclave—where it stores the information referring to timing measurements. These regions lay on the firmware private memory and are not accessible by any other software. Whenever the enclave requests to start a measurement, the firmware writes the current value of the hardware clock (in cycles, e.g., the number of cycles from an oscillator of the hardware clock determined from a signal thereof) into the dedicated memory region and the hardware clock keeps counting cycles as usual. If there is an interruption, or the execution of the enclave is stopped, the firmware updates the corresponding elapsed time value in the private memory region accordingly. When the execution is resumed, the firmware writes down the resume time and so on till the enclave decides to stop the timer. At that time, there are two available values: one refers to the actual elapsed clock cycles and the other one refers to the time that the enclave has been running. If there are no interruptions, the two values are equal.

A first aspect of the present disclosure provides a method enabling trusted timing services to an enclave of a computer having memory and a trusted hardware timer. The computer executes a privileged management program and an untrusted operating system. The privileged management program has access to the memory and the trusted hardware timer, has higher privileges than the untrusted operating system, and exposes a system call to the enclave for requesting the trusted timing services. The method includes: receiving, by the privileged management program, a request for timing services from the enclave, via the system call; reserving, by the privileged management program, a memory region of the memory for tracking time; and writing, by the privileged management program, at least one value of the trusted hardware timer into the memory region

According to a second aspect of the present disclosure, the method according to the first aspect may further include: sending, by the privileged management program in response to receiving a request from the enclave, a time measurement based on the at least one value written in the memory region to the enclave.

According to a third aspect of the present disclosure, in a method according to at least one of the preceding aspects, the memory includes protected memory having the memory region, and the privileged management program has exclusive access to the protected memory.

According to a fourth aspect of the present disclosure, in a method according to at least one of the preceding aspects, the enclave is one of a plurality of enclaves of the computer, and the method further includes: receiving, by the privileged management program, a request for timing services from a second enclave of the enclaves via the system call; reserving, by the privileged management program, a second memory region of the protected memory for tracking time for the second enclave; and writing, by the privileged management program, at least one value of the trusted hardware timer into the second memory region.

According to a fifth aspect of the present disclosure, in a method according to the at least one of preceding aspects, the privileged management program is firmware of the computer.

According to a sixth aspect of the present disclosure, a method according to at least one of the preceding aspects further includes, based on detecting an interruption, an exception, or a context switch involving the enclave, writing, by the privileged management program, at least one further value of the trusted hardware timer and information on the interruption or context switch into the memory region.

According to a seventh aspect of the present disclosure, in a method according to at least one of the preceding aspects, reserving the memory region occurs prior to receiving the system call and includes: reserving a page of protected memory, the page having an enclave identification field, a running field, a CPU start time field, and an enclave start time field; and associating the page to the enclave by writing to the enclave identification field. The privileged management program exposes a plurality of system calls to the enclave for requesting the trusted timing services. The system calls include the system call, and the system call is a timer start system call. The writing, by the privileged management program, the at least one value of the trusted hardware timer into the memory region is in response to receiving the timer start system call and comprises writing in the CPU start time field and the enclave start time field based on a current value of the trusted hardware timer, and the method further includes updating the running field to true.

According to an eighth aspect of the present disclosure, in a method according to at least one of the preceding aspects, the page of protected memory further includes an enclave elapsed time field and at least one timer interruption cause counter, and the method further includes: based an interruption, an exception, or a context switch involving the enclave occurring; updating, by the privileged management program, the enclave elapsed time field based on the enclave start time field, a current value of the trusted hardware timer, and a current value of the enclave elapsed time field; and incrementing, by the privileged management program, the at least one timer interruption cause counter, and based on execution of the enclave resuming after the interruption, the exception, or the context switch: overwriting, by the privileged management program, the enclave start time field based on a current value from the trusted hardware timer.

According to a ninth aspect of the present disclosure, in a method according to at least one of the preceding aspects, the page of protected memory further includes an enclave elapsed time field, and a total elapsed time field. The method further includes: receiving, by the privileged management program from the enclave, a timer stop system call, the system calls include the timer stop system call; updating, by the privileged management program, the running field to false; updating, by the privileged management program, the total elapsed time field based on a current value of the CPU start time field and a current value of the trusted hardware timer; updating, by the privileged management program, the enclave elapsed time field based on the enclave start time field, the current value of the trusted hardware timer, and a current value of the enclave elapsed time field; and sending, by the privileged management program, a report to the enclave, the report having an indication on whether or not the enclave was interrupted and one or more of current values of the enclave elapsed time field, the total elapsed time field; the CPU start time field, or the enclave start time field.

According to a tenth aspect of the present disclosure, in a method according to at least one of the preceding aspects, the page of protected memory further has an enclave elapsed time field, and a total elapsed time field, and the method further includes: receiving, by the privileged management program from the enclave, a timer report system call, the system calls comprising the timer report system call; calculating, by the privileged management program, a total elapsed time based on a current value of the CPU start time field and a current value of the trusted hardware timer; calculating, by the privileged management program, an enclave elapsed time based on the enclave start time field, the current value of the trusted hardware timer, and a current value of the enclave elapsed time field; generating, by the privileged management program, a report to the enclave, the report comprising one or more of the enclave elapsed time, the total elapsed time; an indication on whether or not the enclave was interrupted, or an interruption count; signing, by the privileged management program, the report with a cryptographic key; and sending, by the privileged management program, the signed report to the enclave.

According to an eleventh aspect of the present disclosure, in a method according to at least one of the preceding aspects, during the reserving, by the privileged management program, the memory region is executed based on the enclave being instantiated; and the method further includes: based on determining that the exclave has requested termination, releasing the reserved memory region.

According to a twelfth aspect of the present disclosure, in a method according to at least one of the preceding aspects, the method further includes: determining, by the privileged management program, a time measurement based on the at least one value of the trusted hardware timer written in the memory region; encrypting, by the privileged management program, the time measurement; and sending, by the privileged management program, the encrypted time measurement to the untrusted operating system for storage.

According to a thirteenth aspect of the present disclosure, in a method according to at least one of the preceding aspects, the time measurements are encrypted using a current key, the current key being derived based on a current state of the enclave and a base key or a previous key.

According to a fourteenth aspect of the present disclosure, a system is provided that is configured to enable trusted timing services to an enclave, the system having: a trusted hardware timer; memory, the memory storing a privileged management program and an untrusted operating system, the privileged management program being configured to: have access the memory and the trusted hardware, to expose a system call to the enclave for requesting the trusted timing services, and have higher system privileges than the untrusted operating system; and one or more hardware processors in communication with the memory and the trusted hardware timer, the hardware processors, alone or in combination, are configured to provide the enclave, and are configured to execute the privileged management program such that the method according to at least one of the first through thirteen aspects are executed.

According to a fifteenth aspect of the present disclosure, a tangible, non-transitory computer-readable medium is provided, which has instructions thereon which, upon being executed by one or more hardware processors, alone or in combination, are configured to execute a method according to at least one of the first through thirteenth aspects. The computer readable medium may be included in the system according to the fourteenth aspect.

According to another aspect of the present disclosure, a method is provided that provides a trusted mechanism to enclaves to measure elapsed time via system calls to a piece of trusted firmware running on the machine. The method includes at least one of the following operations:
1. The most privileged firmware is modified to implement and expose to the TEEs some system calls, so they can access the timing services.
2. When an enclave requests a timer, the most privileged software reserves a private memory region to track time for that enclave, and starts monitoring time.
3. Whenever interruptions occur, the most privileged software is triggered. If the interrupted enclave has already requested any timer, the firmware will annotate the interruption reason and update all the necessary fields on the private enclave timing tracking region according to the current value of the hardware timer. Analogously, it will update the necessary fields when the execution of the enclave is resumed.
4. When an enclave stops a timer, the most privileged software stops monitoring time and computes the elapsed time taking into account the value of the hardware timer.
5. When the enclave requests its timing measurements, the most privileged software passes them to the enclave.

An “enclave” according to the present disclosure is a hardware-supported shielded environment for executing applications, which ensures isolation from the rest of the software stack; a trusted execution environment (TEE) is an enclave. “Firmware” according to the present disclosure is (generally) the highest privileged software running on the device, which provides low-level control of the hardware and higher-level hardware abstractions services to other components. As used in the present disclosure, a “component” refers to any portion of a system, e.g., hardware, software, firmware, an OS, an application, a timer, etc. “Privileged” according to the present disclosure means that the relevant component (e.g., application) has direct access (e.g., read and/or write) to hardware or software resources. A “higher privileged” element has greater access than a “lower privileged” element. A “most privileged” element is the element having the greatest access in the system as compared to other elements, particularly the highest access to trusted hardware resources (e.g., firmware is generally the “most privileged” application, with direct access to trusted hardware resources, including protected memory) and whose execution cannot be interrupted by other elements running at lower privilege levels. “Trusted” according to the present disclosure means that the element (firmware, software, hardware, application, program, etc.) can be relied upon to a pre-specified extent in relation to other components to perform tasks without secretly executing harmful, malicious, or unauthorized programs. “Reliable” according to the present disclosure means that the reliable component can perform its function at least under specified conditions for a specified time, without interruption.

A “coarse grain” clock service, provides time resolution in orders of magnitude coarser than the time it takes to execute the piece of code being measured, e.g., milliseconds, rendering such clock service less preferred for accurately measuring the execution time of the aforementioned piece of code whereas a “fine-grained” clock service provides resolution in a similar or the same order of magnitude as hardware clock cycles which enables the accurate measurement of the execution time of even a single instruction. A “protected memory region,” “private memory region,” or “exclusive memory region” is a region of hardware memory accessible by a specific component (e.g., the firmware), but is inaccessible other components (e.g., the OS). Being able to “access” a specific resource or component, or having “access to” a specific resource or component according to the present disclosure means that the component that has such access to the specific resource can directly utilize the resource itself or utilize information in the resource, without having to make a request to any intermediate component having higher privileges to the specific resource or component.

Accordingly, aspects of the present disclosure provide technological improvements in the field of computer processing units (ComPUs), and more particularly to ComPUs having trusted execution environments (TEEs). For example, aspects of the present disclosure improve the security of TEEs (including the securing of applications running at least partially in the TEEs) and improve processing time, as compared to ComPUs with TEEs that do not have the secured time measurement mechanism offered by the present disclosure.

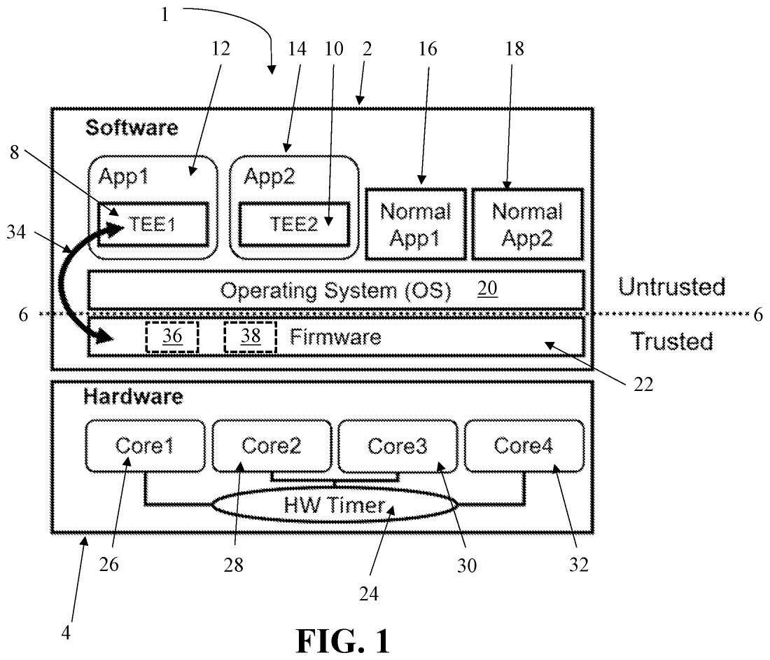

FIG. 1 illustrates a system model 1 according to an embodiment of the present disclosure. The system model 1 includes software 2 and hardware 4. Within the system model 1, there are trusted and untrusted portions. In FIG. 1, everything above trust line 6, except for TEE 8 and TEE 10, is untrusted. This means that, in the embodiment of FIG. 1, even though App 12 and App 14 may not themselves be trusted (absent attestation), the TEE 8 within App 12 and the TEE 10 within App 14 may be trusted (at least internally to the system model 1).

Along with the TEEs 8, 10, the hardware 4 and firmware 22 (e.g., as stored trusted program), below the OS 20 and the trust line 6 of FIG. 1 are trusted. The processor is equipped with a hardware timer, HW timer 24 (e.g., a clock or a hardware counter that counts the number of cycles, e.g., wall cycles, from the signal obtained from an oscillator) that can only be accessed and modified only by highly privileged code running on the machine (e.g., the most-privileged firmware 22 in the embodiment of FIG. 1). The values of HW timer 24 can be accessed by all the central-processing unit (CPU) cores 26, 28, 30, 32, and the time value they see is exactly the same. The HW timer 24 may or may not be additionally powered by an external battery, which would allow it to maintain the count even when the machine is powered off.

According to an embodiment, the application operating in the most privileged operation mode of the system model 1 is the firmware 22 running on the machine, which can get different names depending on the architecture, and has complete access to all components of hardware 4. Such firmware 22 is included in the trusted computing base (TCB). It guarantees that the hardware 4 providing security guarantees for the TEE, e.g., TEE 8, is properly configured and used. For instance, firmware 22 will be the one either configuring and launching the TEE 8, 10 or verifying that the OS 20 has done so in an appropriate way. The firmware 22 is notified whenever there is a hardware 4 interruption or an exception and firmware 22 either executes some software routine as a response and/or delegates software routine to another entity, e.g., the OS 20. Generally, if one component is more privileged than another component (e.g., as the firmware is more privileged than the OS in the present embodiment), this means that the more privileged operation or component has access to or can change the less privileged operation or component, but the less privileged component is restricted from accessing or changing the more privileged component. In the system model 1, as the most privileged software running on the machine, firmware 22 cannot be interrupted while executing unless it allows such interruptions. The rest of the components can communicate with the firmware via a clearly defined interface, which embodiments of the present disclosure enhance to include functions to carry out timing measurements for enclaves, and to get a signed report verifiable by a third party.

The OS 20 runs on top of the firmware 22. It runs at higher privilege level than regular applications, e.g., normal app 16 and normal app 18, but at lower privilege level than the firmware 22. The OS may be a general purpose OS 20, that is, embodiments of the present disclosure do not require modification of the OS 20 to be implemented. The OS 20 commonly handles inter-process communication, task scheduling, most of the interruptions and exceptions, and holds the majority of the drivers for handling peripherals. As a result, it can schedule and de-schedule an enclave process, e.g., TEE 8 process, at will, interrupt it, or except it from execution. In all of these cases, the privileged firmware 22 can get notified of the changes, and firmware 22 will not prevent them. In any case, the OS 20 is not part of the TCB. Hence, the OS 20 cannot act as timekeeper because it may not accurately report timing information. For example, a compromised OS 20 may try to delay or modify timing measurements requested by an enclave, e.g., TEE 8.

Finally, the enclaves, e.g., TEE 8, 10, run in isolated containers with their code protected from the rest of the untrusted software of the system, including the OS 20. They can only communicate with the outside world using specific entry and exit points, e.g., the system calls 34 exposed by embodiments of the present disclosure. As shown in FIG. 1, TEEs 8, 10 communicate directly with the firmware 22 when they use the provided system calls 34, and the OS 20 has no means by which to intercept such communication.

Reliable Time Measurements

Timers can be used with each memory region, among other things, to either (1) generate reports (e.g., attestation or proof of elapsed time) for benchmarking, to prevent, e.g., time of check, time of use exploits, e.g., a file-based race condition that occurs when a resource is checked for a particular value, such as whether a file exists or not, and that value then changes before the resource is used, invalidating the results of the check; or (2) to provide temporal forensic capabilities to enclave developers, to detect attacks on code integrity and even for time based attestation protocols. The timers can utilize HW timer 24, and can operate in conjunction with a memory region, e.g., memory region 36, 38.

An embodiment of the present disclosure reserves a memory region 36, e.g., a page, which is then associated to an enclave, e.g., TEE 8, and can do so for each of the enclaves, e.g., for TEE 8, 10, memory regions 36, 38 are reserved. Such memory region 36 can contain private information referring to TEE 8, for example, the memory region 36 that is accessible from TEE 8 and the input/output interfaces of TEE 8, and memory region 36 is formed from a portion of memory only accessible for the firmware 22 of the machine. If the entity or firmware 22 handling TEE 8 already holds some structure to keep track of some other information referring to TEE 8, that structure can be enhanced so that the structure can hold the necessary information to compute the timing measurements. A malicious or compromised OS might try to remove from firmware 22 pages, e.g., memory regions 36, from the dynamic random access memory (DRAM) in order to cause delays on timing measurements. To avoid this situation, the firmware 22 will ensure that these memory regions 36 are not removed from the DRAM by any other entity. Additionally, the firmware 22 can monitor the notifications received regarding the OS 20 and the TEE 8 and issue commands in response to the notifications. For example, the firmware 22 can monitor the notifications of actions taken by the OS 20 and issue calls, e.g., timer stop, timer start (below), on its own, instead of having the TEE 8 issue those calls. In some of these embodiments where firmware 22 issues calls on behalf or in addition to TEE 8, the entity tracking the time could be the shared memory, using an additional and independent portion of the memory, for example for tracking or monitoring the performance of the system. These embodiments could utilize memory, e.g., shared memory, independent of the timing information provided to the TEE 8 as per its request.

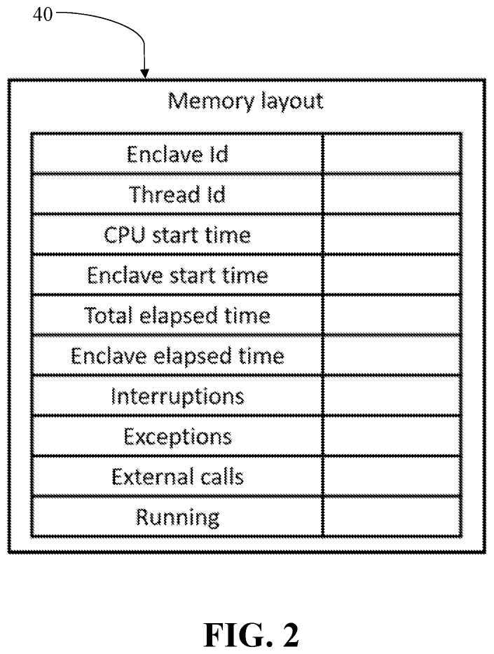

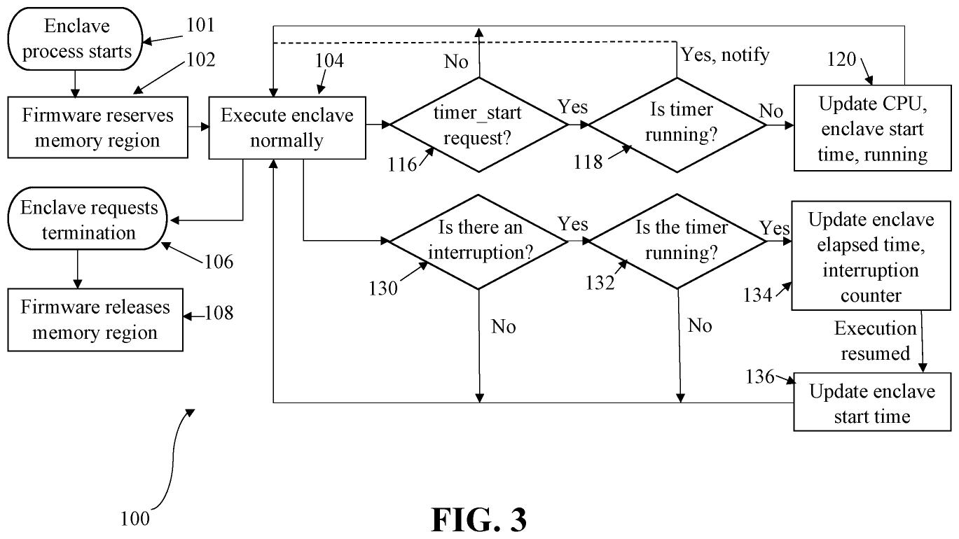

An example layout 40 with different fields which can be used to track time is depicted in FIG. 2. The layout 40 of FIG. 2 is operable to track time and operations with other embodiments of the present disclosure, e.g., FIGS. 1 and 3. For example, the external calls cell of example layout 40 can keep track of and/or count any calls to any source external to the TEE 8, while the total elapsed time cell can track the total time that has elapsed from a reference point in time. In embodiments, the example layout can have some cells filled with integer values, e.g., the interruption or exception cell can display a counter of the number of interruptions or experienced, or the running cell can be a binary 0 or 1 to indicate yes or no, time values, e.g., CPU start time and enclave start time, and word or numeric sequence, e.g., yes or no for the running cell and numeric sequences indicating the thread and enclave id.

In order to simplify the management of the timers for all the possible enclaves, e.g., TEE 8, 10, that might be running on the system model 1, the firmware 22 could have some variables indicating the active timers. Thus, a variable can be consulted whenever there is an interruption or a context switch from TEE 8 to another process, and then only the memory regions 38 of the active timers for the active TEE 10 will be updated. An easy way to implement this is to assign to each timer an id equal to the position of the bit that will be set to 1 in the variables. For example, one variable whose binary representation is equal to 0xb000010010 indicates that the timers 1 and 4 are running. Alternatively, the firmware 22 could check the running field of each of the enclaves, e.g., TEE 8, 10. Pseudocode is provided below as an example of how a variable can be consulted whenever there is an interruption or a context switch from TEE 8 to another process.

Assuming the system has just booted, and TEE IDs, e.g., IDs for TEE 8, 10, are assigned sequentially by the firmware 22, then we have:

Mask_active_timers = 0x00000;
# New timer is activated
Mask_new = 0x1<<(enclave id) // shift 1 bit to activate the corresponding bit to the
enclave id
Mask_active_timers = Mask_active_timers OR Mask_new
# New interruption
If interruption:

For i=0 till number of enclaves:

Check bit number i of mask_active_timers
If bit == 1 : // timer running

Update region for enclave i

The pseudocode for updating a memory region, e.g., memory region 36, 38, if there is an interruption or exception could be executed by the firmware 22 and may be directly invoked by the TEEs, e.g., TEE 8, 10 (although an interruption or exception could be indirectly invoked if the TEEs cause an interruption, or if they make an external call to another function). The following pseudocode assumes the TEE is running as the function that is calling it has already checked that condition. So the update function can be as follows:

Update_function (enclave id, invocation cause)

If (invocation cause == interruption) OR (invocation cause ==

exception) OR (invocation cause == external call):

Enclave elapsed time += (wall time - Enclave start time);
If (invocation cause == interruption):
Interruptions++;
If (invocation cause == interruption):
Exception++;
If (invocation cause == interruption):
External calls++;

Else:
#Resume execution
Enclave start time = wall_time;

According to an embodiment, the firmware 22 is modified to expose four different calls to the software 2 running in TEE 8, 10, namely: timer_start, timer_stop, time_report and timer_reset. In the embodiment of FIG. 1, these four different calls can resemble the following:
timer start: Upon receiving this call, the firmware 22 checks if the timer is already running. If so, it notifies TEE 8 and does nothing. If not, it writes on the memory region 36 dedicated to TEE 8 the current value of the HW timer 24 in the “CPU start time” and “enclave start time” fields, one for wall cycles, e.g., HW timer cycles, and a second one for enclave cycles. Moreover, firmware 22 sets the “running” field to 1. If the execution of TEE 8 is interrupted by any cause, the firmware 22 reads the HW timer 24 value, and updates a field of “Enclave elapsed time” by subtracting the initial value in the “enclave start time” field from the current time and stores the result on that field. It also increases the counter of the cause of the interruption in the appropriate cause counter. Once TEE 8 execution is resumed, the firmware 22 overwrites the “enclave start time” field with the current time. An example embodiment is also provided as pseudocode:

| ## Timer start function gets enclave id as input | |
|---|---|
| Read Memory region for (enlave id) | |
| If Running == TRUE: | |
| | Return “timer already running” |
| Else: | |
| | CPU start time = wall time; |

Enclave start time = CPU start time;

Running = TRUE;

Thread ID = calling thread id // Not always needed.

timer stop: This call stops the count, and the firmware 22 then computes the real elapsed time by subtracting the value in the “CPU start time” from the current time. For the enclave elapsed time, it first checks whether the enclave was interrupted or not since the timer was started by comparing CPU and Enclave start times. If not, i.e. the two aforementioned values are equal, the enclave time is the same as in the previous case, on the other hand it first subtracts the value on the initial enclave time field from the current time and then adds whatever the elapsed time field holds. Then it returns a report with all the information to TEE 8. If the OS 20 then interrupts TEE 8 before it can actually use that information, the firmware 22 will notify TEE 8 and update the value of “real elapsed time.” An example embodiment is also provided as pseudocode:

| ## Timer stop function gets enclave id as input | |
|---|---|
| Read Memory region for (enlave id) | |
| If Running == FALSE: | |
| | Return “timer not running” |
| Else: | |
| | Total elapsed time = wall time - CPU start time |
| | If (CPU start time == Enclave start time): |

Enclave elapsed time = Total elapsed time

Else:

Enclave elapsed time = Enclave elapsed time + (wall time -

Enclave start time)

Running = FALSE;

timer report: This call generates a signed report for TEE 8 with the information included in the memory layout 40 of FIG. 2. If the timer is still running, the report creates a snapshot of the current state of the timing measurements updating the values as it would do when timer_stop is executed, but it allows the count to keep going. That is, the “running” field is not modified. This signed report allows the receiving enclave, e.g., TEE 8, to send a proof of elapsed time to an external party, like an attestation report. An example embodiment is also provided as pseudocode:
##Timer report function gets enclave id as input
Read Memory region for (enclave id)
Return a copy of that memory region;
timer reset: Even when the timer has been stopped, the values held by the firmware 22 are not modified (except for the running field). TEE 8 might want to restart the count and reset the number of instructions and the elapsed times. This instruction allows it to do so. This function does not manipulate nor change the values of the actual HW timer 24. An example embodiment is also provided as pseudocode:

| ## Timer reset function gets enclave id as input | |
|---|---|
| Read Memory region for (enlave id) | |
| If Running == TRUE: | |
| | Return “timer running stop it first” |
| Else: | |
| | CPU start time 0; |
| | Enclave start time = 0 |
| | Total elapsed time = 0; |
| | Enclave elapsed time = 0; |
| | Interruptions = 0; |
| | Exception = 0; |
| | External calls = 0; |

Running = FALSE;

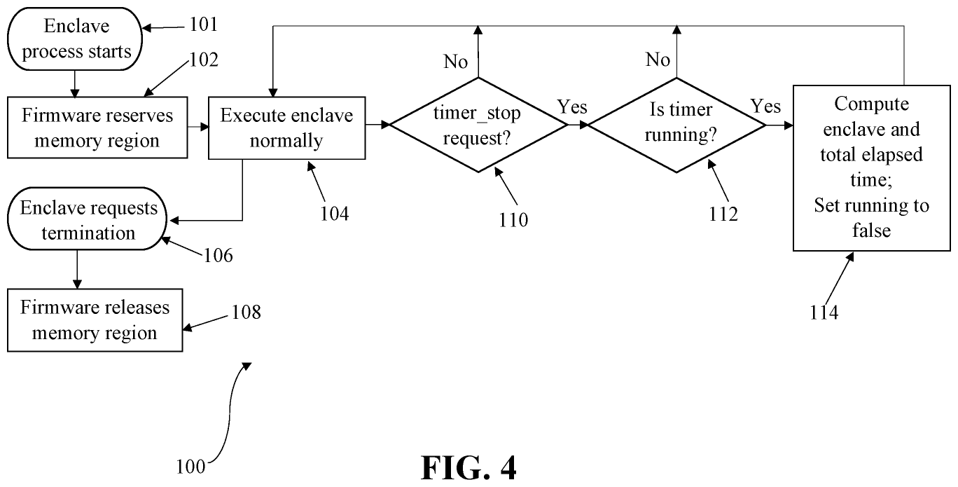

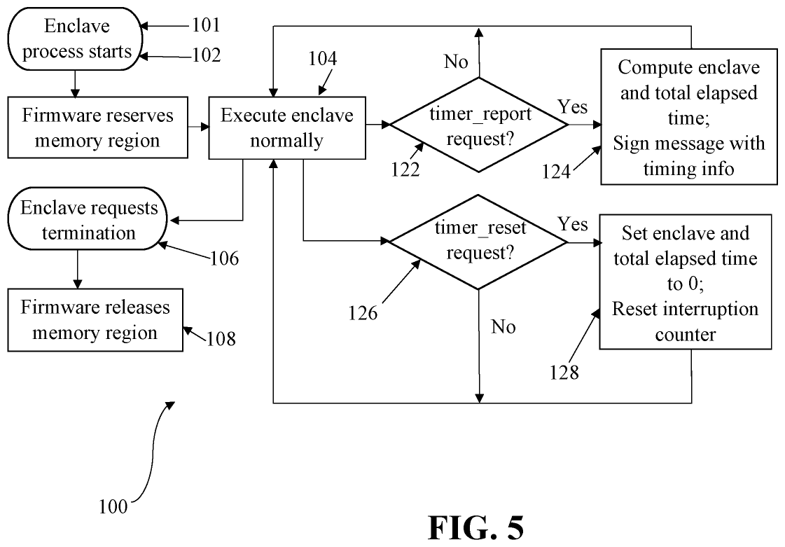

An embodiment of a procedure 100 to measure time is described by the diagrams in FIGS. 3, 4, and 5, and refers to the actions taken by the firmware 22 with reference to the field names in FIG. 2.

In the embodiment of procedure 100, at step 101 an enclave process can start, e.g., code is executed in or by the TEE, such as TEE 8 of FIG. 1. At step 102, the firmware, such as firmware 22, can reserve an exclusive memory region, such as memory region 36, for a timer to operate. At step 104, the enclave is executing as normal, and the firmware has provided an exclusive memory region for the enclave. At step 106, the enclave requests termination, which can mean that the enclave has finished executing its main task and may not require the resources assigned to it, at which point the firmware can clean and free up the memory region for subsequent reuse, e.g., by a different enclave or a different process. At step 108, the firmware releases the timer and can provide any recorded information related to the timer requested by the enclave. The memory region is then terminated.

In the embodiment of procedure 100, if a timer_stop request is received by the firmware at step 110, a check can be performed to verify if the timer is running at step 112. If the timer is not running, the enclave continues to execute as normal, whether normal execution is active execution of code or not. If the timer is running at step 112, then in step 114 the total elapsed time of the enclave or timer and the total elapsed time of the hardware clock, e.g., HW Timer 24 of FIG. 1, can be computed and the running value in the table of FIG. 2 can be set to false. The enclave then proceeds to execute as normal.

If a timer_start request is received at step 116, a check can be performed at step 118 to verify if the timer is running. If the timer is running, a notification can be sent that the timer is running. If the timer is not running at step 118, the CPU start time and enclave or timer start time fields can be updated, and the running value in the table of FIG. 2 can be set to true. The enclave then proceeds to execute normally.

If a timer_report request is received at step 122, the total elapsed time of the enclave or timer and the total elapsed time of the hardware clock can be computed in step 124, and the running value of FIG. 2 set to false. The enclave then proceeds to execute as normal.

If a timer_reset request is received at step 126, the total elapsed time of the enclave or timer and the total elapsed time of the hardware clock can be set to 0 in step 128, and the counters for interruption causes similarly reset. The enclave then proceeds to execute as normal.

If an interruption is detected at any point, as in step 130, a check to verify if the timer is running is performed in step 132. If the timer is not running, the enclave can proceed to execute as normal. If the timer is running in step 132, the total elapsed time of the enclave or timer can be computed in step 134, and the counter for interruption causes can be updated. Once execution of the enclave resumes, the start time of the enclave or timer can be updated in step 136.

An enclave, e.g., TEE 8 is not limited to use one single timer. TEE 8 it could use as many as the firmware 22 allows, as it might prefer to use the available memory for other purposes. For example, in the embodiment of FIG. 1, TEE 8 may use both memory region 36 and 38. The only requirement is that each of the timers in should get a separate memory region 36, 38 and additionally, these memory regions 36, 38 should include an id field so TEE 8 can refer to that particular timer when executing the different system calls 34. Similarly, this proposal could be extended to multithreaded enclaves, therefore allowing each thread to measure its own time. To this end, the memory regions 36, 38 associated with a particular enclave could include a “Thread Id” field as depicted in FIG. 2. In this embodiment, it would be up to TEE 8 to aggregate all the timing measurements from the different threads.

Note that some registers that hold the time of the system can be accessed speculatively or out of order. Embodiments of the present disclosure can avoid this scenario by placing a fence instruction, or a constraint on the order of memory operations issued before or after the instruction, before actually storing the timer value in the memory region, e.g., memory region 36, associated to the enclave, e.g., TEE 8.

Since counters, e.g., hardware counters, usually expose an interface for obtaining or modifying the actual count (e.g., if the system needs to add timestamps to the files and manages to get a reference from a trusted party) and that service could be actually used, embodiments of the present disclosure do not limit this ability. As described before, embodiments can do so by just updating the values on the structure in a procedure similar to interruption or exception handling. For example, this can be similar to internal processes performed by the firmware 22 each time there is an interruption or exception, wherein the TEE does not need to call the update, but firmware 22 will register the interruption or exception to obtain accurate timing measurements.

In order to prevent enclaves, e.g., TEE 8, 10, from abusing the timing measurements to carry out microarchitectural attacks, embodiments of the present disclosure can let the firmware 22 decide when it deems that an enclave is behaving maliciously, such as by requesting a timing measurement each few cycles. In embodiments where the enclave is deemed to behave maliciously, and under the assumption that the enclave is not running a critical piece of code like the break control system on an autonomous car, it could deny the access to the enclave. In an embodiment, the firmware 22 can set a threshold amount of requests per a certain amount of cycles, e.g., by setting the threshold amount depending on a specific type of behavior to be identified, and identify malicious behavior by comparing the amount of requests received to the threshold number of requests. For example, if the amount of requests received exceeds the threshold amount, the firmware 22 can determine that the enclave is acting maliciously. In an embodiment, the firmware 22 can acquire information from another source, e.g., hardware performance counters, and correlate that information with the requests or amounts thereof. For example, in a cache attack, if multiple requests are occurring simultaneously with cache misses, the firmware 22 can determine that the enclave is acting maliciously as it is likely that the enclave is measuring and generating cache misses as it happens.

Implementation for Different Architectures

Different architectures have different ways to expose time measurements and also have different requirements for the implementation of the trusted functions. Thus, the present disclosure provides three embodiments, among the various embodiments, to cover three well-known architectures, namely x86, ARM and Risc-V. For example ARM exposes the EL1 physical timer through the CNTPCT_EL0 register. Intel (x86) includes a high resolution timestamp counter accessible through the RDTSC instruction and Risc-V platforms have to provide a real-time counter exposed as a memory register called MTIME to machine mode software. As a person of ordinary skill in the art would understand, the embodiments may be combined and/or adapted to other architectures without departing from the spirit or scope of the present disclosure.

X86

As of now, Intel SGX is the most used platform that supports enclaves. SGX used to offer access to a low resolution timer to the enclaves, although such feature is now deprecated due to some implementation issues. Further, the procedure SGX was using was shown to be vulnerable to delay attacks, since the service was provided by an architectural enclave, which is a permanent enclave of the platform, and required inter-enclave communication which was only possible through the OS. An alternative for enclaves that wished to use timers was to implement a counting thread, but since it can be interrupted by the OS, it provides no guarantee at all.

SGX already stores some information for each of the enclaves on its private memory, like the assigned pages to each enclave and where are these pages placed on memory. According to the present disclosure, fields are added to that information to keep track of the time. Differently to their design, embodiments of the present disclosure may not use an architectural enclave to offer the timing information to the rest of the enclaves; instead, the most privileged firmware is modified so it can be directly called by the enclaves, effectively avoiding IPC and delays introduced by the OS. Further, in this case, besides tracking interruptions and exception this invention also tracks time for the ocalls executed by the enclave and the report is signed with the SGX key. The firmware runs either at system management mode (SMM) or as management engine (ME) mode, the most privileged mode. Both modes are more privileged than the OS or hypervisor and therefore the code running on such modes is trusted.

RISC-V

Risc-V based TEEs usually provide memory isolation to the enclaves by using some physical memory protection (PMP) registers that hold information referring to the memory regions that are accessible to that particular enclave and their access privileges (read, write, execute). In this case there are also different privilege modes for the code, the most privileged one is known as machine mode. The security monitor is the entity in charge of configuring the PMP registers and providing all the guarantees to the enclaves and it is therefore trusted. As such it is the only code with access to the mtime register, which in turn holds the timing information.

Every Risc-v based machine implements some sort of security monitor because it has complete access to the hardware and the only mode capable of configuring it. According to an aspect of the present disclosure, the code to support the aforementioned system calls is added to the security monitor, and the security monitor in turn uses the information from the mtime register for the measurements.

ARM

ARM Trustzone distinguishes two different worlds, the secure world where the code runs in trusted execution environments (TEEs) and the normal world or rich execution environment. A monitor running in so-called monitor mode takes care of switching between the two modes. A problem with Trustzone is that it does not have a dedicated timer for the secure world, so the OS running in the TEE could modify the timer even for legitimate purpose. Therefore, according to an aspect of the present disclosure, each modification is tracked so it is possible to undo them to measure the actual elapsed time.

Implementations for Trustzone are similar to implementations for Risc-V. The monitor can be modified to support the exposed system calls and can register any interruption or alteration of the execution of the enclave on the area reserved to that end.

Persistent Storage

For storing timing measurements persistently, an enclave partially relies on the OS, because it is in charge of handling the devices to which the data is written to, e.g., a hard drive. The time measurements that are stored persistently might comprise multiple measurements of the enclave over a period of time. The confidentially and also the integrity of the time measurements can be protected by encrypting them before handing them over to the OS for writing them to disk. However, although the firmware and also the enclave both have a sense of time, they cannot determine the order in which time measurements were written to disk. In particular, the enclave cannot infer whether an encrypted time measurement provided by the OS to the enclave is the latest one that the enclave previously requested to be written to disk. This opens the possibility for a malicious OS to mount so-called rollback attacks by proving stale state information to enclaves.

To prevent the OS for providing stale time measurements, the firmware may have access to some private and persistent storage. The storage size may be limited, however. Note that a Trusted Platform Module (TPM) already provides such limited storage capabilities. However, the access to TPM storage can be slow and the storage can wear out quickly. Furthermore, there can be a significant overhead when communicating with a TPM. For performance reasons, the firmware has its own persistent storage, which it controls and which it can access directly.

Instead of using the same key for encrypting timing measurements, the key is altered to infer in which order timing measurements were stored. A base key, which is a combination of the machine key, is provided by the underlying hardware, and the identity of the enclave is known. The firmware or the underlying hardware derives an encryption key from the enclave state (e.g. a hash of the data to be stored), and the previous key (if there is no previous key, its value is set to the base key). This newly derived key is used by the firmware to encrypt the current time measurements. The firmware stores the current key in its persistent storage once the OS has written the encrypted time measurements to disk. This allows the firmware later to decrypt the latest encrypted time measurements. It also prevents the OS from providing stale data. If it tries to do so, the data will not be decrypted by the firmware as the current key is not the key that was used to encrypt this data. A different approach would be to always use the same key and store a freshness tag that summarizes the execution history of the enclave as they do in Parno et al., “Memoir: Practical State Continuity for Protected Modules,” IEEE Symposium on Security and Privacy (2011) (the entire contents of which is hereby incorporated by reference herein). In such approach, data is decrypted and the tag is compared to deem the data as valid. An example embodiment of this approach is also provided as pseudocode:

# The key derivation function gets as input the enclave id and the data to be stored,
e.g. timing measurements in this case.
Get_enclave_key (enclave id, data to be stored)
{

If there was no previous key stored:

Enclave key = hash(machine_key, enclave hash) // base key;

Else:

Enclave key = hash(prev_key, hash(data to be stored))

}
Encrypt data to be stored and write it to disc;
Save Enclave key as prev_key;

Embodiments of the present disclosure are not limited to the storage of time measurements persistently on any piece of hardware controlled by an untrusted OS. Indeed, embodiments can be used to store any data the enclave wants to store persistently, i.e., it can be used to seal enclave data in general to any kind of persistent storage, e.g., flash memory, hard disk drive, solid state drive. Embodiments can also be used to track or assist with any regular process running at user mode, e.g., any process that could be completely under the control of the OS. In that case, the protection could be against other unprivileged processes, even if vulnerable to malicious attacks from the same or higher privilege as the OS, including the OS itself.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method for providing trusted timing services to an enclave of a computer comprising memory and a trusted hardware timer, the computer executing a privileged management program and an untrusted operating system, the privileged management program having access to the memory and the trusted hardware timer, having higher privileges than the untrusted operating system, and exposing a system call to the enclave for requesting the trusted timing services, the method comprising:
receiving, by the privileged management program, a request for timing services from the enclave, via the system call;
reserving, by the privileged management program, a memory region of the memory for tracking time; and
writing, by the privileged management program, at least one value of the trusted hardware timer into the memory region.

2. The method according to claim 1, the method further comprising:
sending, by the privileged management program in response to receiving a request from the enclave, a time measurement based on the at least one value written in the memory region to the enclave.

3. The method of claim 1, wherein the memory comprises protected memory comprising the memory region, the privileged management program having exclusive access to the protected memory.

4. The method of claim 3, wherein the enclave is one of a plurality of enclaves of the computer, the method further comprising:
receiving, by the privileged management program, a request for timing services from a second enclave of the enclaves via the system call;
reserving, by the privileged management program, a second memory region of the protected memory for tracking time for the second enclave; and
writing, by the privileged management program, at least one value of the trusted hardware timer into the second memory region.

5. The method of claim 1, wherein the privileged management program is firmware of the computer.

6. The method of claim 1, the method comprising, based on detecting an interruption, an exception, or a context switch involving the enclave, writing, by the privileged management program, at least one further value of the trusted hardware timer and information on the interruption or context switch into the memory region.

7. The method of claim 1,
wherein reserving the memory region occurs prior to receiving the system call and comprises:
reserving a page of protected memory, the page comprising an enclave identification field, a running field, a CPU start time field, and an enclave start time field; and
associating the page to the enclave by writing to the enclave identification field;
wherein the privileged management program exposes a plurality of system calls to the enclave for requesting the trusted timing services, the system calls comprising the system call, the system call being a timer start system call,
wherein the writing, by the privileged management program, the at least one value of the trusted hardware timer into the memory region is in response to receiving the timer start system call and comprises writing in the CPU start time field and the enclave start time field based on a current value of the trusted hardware timer, and
wherein the method further comprises updating the running field to true.

8. The method of claim 7,
wherein the page of protected memory further comprises an enclave elapsed time field and at least one timer interruption cause counter,
wherein the method further comprises:
based an interruption, an exception, or a context switch involving the enclave occurring:
updating, by the privileged management program, the enclave elapsed time field based on the enclave start time field, a current value of the trusted hardware timer, and a current value of the enclave elapsed time field; and
incrementing, by the privileged management program, the at least one timer interruption cause counter, and
based on execution of the enclave resuming after the interruption, the exception, or the context switch:
overwriting, by the privileged management program, the enclave start time field based on a current value from the trusted hardware timer.

9. The method of claim 7,
wherein the page of protected memory further comprises an enclave elapsed time field, and a total elapsed time field,
wherein the method further comprises:
receiving, by the privileged management program from the enclave, a timer stop system call, the system calls comprising the timer stop system call;
updating, by the privileged management program, the running field to false;
updating, by the privileged management program, the total elapsed time field based on a current value of the CPU start time field and a current value of the trusted hardware timer;
updating, by the privileged management program, the enclave elapsed time field based on the enclave start time field, the current value of the trusted hardware timer, and a current value of the enclave elapsed time field; and
sending, by the privileged management program, a report to the enclave, the report comprising an indication on whether or not the enclave was interrupted and one or more of current values of the enclave elapsed time field, the total elapsed time field; the CPU start time field, or the enclave start time field.

10. The method of claim 7,
wherein the page of protected memory further comprises an enclave elapsed time field, and a total elapsed time field,
wherein the method further comprises:
receiving, by the privileged management program from the enclave, a timer report system call, the system calls comprising the timer report system call;
calculating, by the privileged management program, a total elapsed time based on a current value of the CPU start time field and a current value of the trusted hardware timer;
calculating, by the privileged management program, an enclave elapsed time based on the enclave start time field, the current value of the trusted hardware timer, and a current value of the enclave elapsed time field;
generating, by the privileged management program, a report to the enclave, the report comprising one or more of the enclave elapsed time, the total elapsed time; an indication on whether or not the enclave was interrupted, or an interruption count;
signing, by the privileged management program, the report with a cryptographic key;
sending, by the privileged management program, the signed report to the enclave.

11. The method of claim 1, wherein the reserving, by the privileged management program, the memory region is executed based on the enclave being instantiated; and wherein the method further comprises: based on determining that the exclave has requested termination, releasing the reserved memory region.

12. The method according to claim 1, the method further comprising:
determining, by the privileged management program, a time measurement based on the at least one value of the trusted hardware timer written in the memory region;
encrypting, by the privileged management program, the time measurement; and
sending, by the privileged management program, the encrypted time measurement to the untrusted operating system for storage.

13. The method according to claim 3, wherein the time measurements are encrypted using a current key, the current key being derived based on a current state of the enclave and a base key or a previous key.

14. A system configured to provide trusted timing services to an enclave, the system comprising:
a trusted hardware timer;
memory, the memory storing a privileged management program and an untrusted operating system, the privileged management program being configured to: have access the memory and the trusted hardware, to expose a system call to the enclave for requesting the trusted timing services, and have higher system privileges than the untrusted operating system; and
one or more hardware processors in communication with the memory and the trusted hardware timer, the hardware processors, alone or in combination, are configured to provide the enclave, and are configured to execute the privileged management program such that:
the privileged management program receives a request for timing services from the enclave via the system call;
the privileged management program reserves a memory region of the memory for tracking time; and
the privileged management program writes at least one value of the trusted hardware timer into the memory region.

15. A tangible, non-transitory computer-readable medium having instructions thereon which, upon being executed by one or more hardware processors, alone or in combination, are configured to execute a privileged management program to provide trusted timing services to an enclave of a computer comprising memory and a trusted hardware timer, the computer being for executing the privileged management program and an untrusted operating system, the privileged management program configured with higher privileges than the untrusted operating system, and the privileged management program being configured to:
have access to the memory and the trusted hardware timer;
expose a system call to the enclave for requesting the trusted timing services;
receive a request for timing services, from the enclave, via the system call;
reserve a memory region of the memory for tracking time; and
write at least one value of the trusted hardware timer into the memory region.
